(19) United States
(12) Patent Application Publication
(10) Pub. No.: US 2016/0189693 A1
(43) Pub. Date: Jun. 30, 2016

(54) NICKEL BRASS CYMBAL HAVING LOW NICKEL CONTENT

(71) Applicant: Avedis Zildjian Co., Norwell, MA (US)

(72) Inventor: Paul Francis, Plymouth, MA (US)

(73) Assignee: Avedis Zildjian Co., Norwell, MA (US)

(21) Appl. No.: 14/743,186

(22) Filed: Jun. 18, 2015

Related U.S. Application Data
(60) Provisional application No. 62/098,193, filed on Dec. 30, 2014.

(51) Int. Cl. G10D 13/06; C22C 9/04

(52) U.S. Cl. CPC G10D 13/06; C22C 9/04

(57) ABSTRACT

According to some aspects, a cymbal is provided comprising a nickel brass primarily comprising copper and further comprising zinc and nickel, wherein the nickel brass comprises between 3 and 9 percent nickel by weight. According to some aspects, a method of producing a cymbal comprising the nickel brass is provided.

### CROSS REFERENCE TO RELATED APPLICATIONS

The present application claims the benefit under 35 U.S.C. §119(e) of U.S. Provisional Patent Application No. 62/098,193, filed Dec. 30, 2014, titled “Nickel Brass Cymbal Having Low Nickel Content,” which is hereby incorporated by reference in its entirety.

### BACKGROUND

The present application relates generally to cymbals and in particular, to a new and improved material from which a cymbal may be formed. Cymbals are metallic percussion instruments that have been used in various forms for centuries, and have typically been made from bronze.

### SUMMARY

According to some aspects, a cymbal is provided comprising a nickel brass primarily comprising copper and further comprising zinc and nickel, wherein the nickel brass comprises between 3 and 9 percent nickel by weight.

According to some aspects, a method of producing a cymbal is provided, the method comprising forming the cymbal from a nickel brass primarily comprising copper and further comprising zinc and nickel, wherein the nickel brass comprises between 3 and 9 percent nickel by weight.

The foregoing is provided by way of illustration and is not intended to be limiting.

### BRIEF DESCRIPTION OF DRAWINGS

Various aspects and embodiments will be described with reference to the following figures. It should be appreciated that the figures are not necessarily drawn to scale. For purposes of clarity, not every component may be labeled in every drawing.

FIG. 1 depicts a cross-section of an illustrative nickel brass cymbal, according to some embodiments; and

FIG. 2 illustrates a method of manufacturing a nickel brass cymbal, according to some embodiments.

### DETAILED DESCRIPTION

Commercial cymbals are typically made from a bronze alloy, which comprise copper and tin in addition to small amounts of other metals such as silver. The most prevalent cymbal bronze alloys include an 80% copper and 20% tin alloy (sometimes called “B20”) and a 92% copper and 8% tin alloy (sometimes called “B8”).

Commercial cymbals may also, in some cases, be formed from brass (an alloy comprising primarily copper and zinc). The acoustic properties of a brass cymbal are generally not as desirable to a musician as those of a bronze cymbal; however, brass is generally less costly than bronze. Accordingly, brass may sometimes be used to produce cheaper, so-called “entry level” cymbals. These cymbals are often made from a brass alloy that comprises nickel in addition to copper and zinc (sometimes called “nickel silver” or “nickel brass”). Such nickel brass cymbals typically include around 12% nickel by weight (with the remainder being entirely, or almost entirely, copper and zinc) and provide a more pleasing tone with a greater sustain when struck compared with a pure brass cymbal. The nickel may also provide anti-tarnish (and/or anti-patina) properties.

The inventor has recognized and appreciated that a nickel brass cymbal formed from around 6% nickel by weight has comparable acoustic performance yet substantially lower cost than a nickel brass cymbal comprising 12% nickel. Previously available nickel brass cymbals comprise at least 12% nickel by weight, and it has been appreciated by the inventor that, contrary to belief within the cymbal industry, an acoustically comparable cymbal may be formed with substantially less nickel content that retains much of the acoustic performance of the higher nickel content cymbals. Since nickel is generally more expensive than copper or zinc, a nickel brass cymbal including around 6% nickel may be less costly than a comparable nickel brass cymbal including around 12% nickel.

According to some embodiments, a cymbal may be formed from nickel brass that includes materials other than copper, zinc and nickel in an amount that is less than one percent by weight of the cymbal. For instance, the nickel brass may primarily comprise copper and may additionally include zinc and nickel such that the copper, zinc and nickel together make up at least 99 percent by weight of the nickel brass. Additional materials may include, but are not limited to, tin, phosphorus, iron, lead, manganese, cadmium, or combinations thereof.

Since cymbals are struck repeatedly over their lifetime during play, it is desirable that they are formed from a material having a yield strength that is sufficiently high to resist deformation from such impacts. In particular, a yield strength greater than 20 ksi (kilopounds per square inch) may be highly desirable for a cymbal alloy. According to some embodiments, a cymbal may be formed from nickel brass having a yield strength greater than 50 ksi and less than 100 ksi. A nickel brass may have any suitable yield strength in addition to comprising any of the copper, zinc and nickel amounts discussed herein. For instance, a cymbal may comprise a nickel brass primarily comprising copper and zinc and comprising 6 percent nickel by weight, wherein the nickel brass has a yield strength greater than 50 ksi and less than 100 ksi.

According to some embodiments, a cymbal may be formed from nickel brass primarily comprising copper and comprising between 20 and 28 percent zinc by weight and between 3 and 9 percent nickel by weight. According to some embodiments, a cymbal may be formed from nickel brass primarily comprising copper and comprising between 22 and 26 percent zinc by weight and between 4 and 8 percent nickel by weight. According to some embodiments, a cymbal may be formed from nickel brass primarily comprising copper and comprising between 23 and 25 percent zinc by weight and between 5 and 7 percent nickel by weight. According to some embodiments, a cymbal may be formed from nickel brass primarily comprising copper and comprising approximately 24 percent zinc by weight and approximately 6 percent nickel by weight. According to some embodiments, a cymbal may be formed from nickel brass primarily comprising copper and comprising between 18 and 22 percent zinc by weight and between 4 and 6 percent nickel by weight. According to some embodiments, a cymbal may be formed from nickel brass primarily comprising copper and comprising between 19.2 and 20.2 percent zinc by weight and between 4.7 and 5.3 percent nickel by weight. According to some embodiments, a cymbal may be formed from nickel brass comprising between 72 and 76 percent copper by weight and between 1.6 and 2.2 percent nickel by weight. According to some embodiments, a cymbal may be formed from nickel brass comprising between 69 and 71 percent copper by weight and between 5.7 and 6.3 percent nickel by weight. According to some embodiments, a cymbal may be formed from nickel brass primarily comprising copper and comprising approximately 24.5 percent zinc by weight and approximately 5.5 percent nickel by weight.

Following below are more detailed descriptions of various concepts related to, and embodiments of, a nickel brass cymbal. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

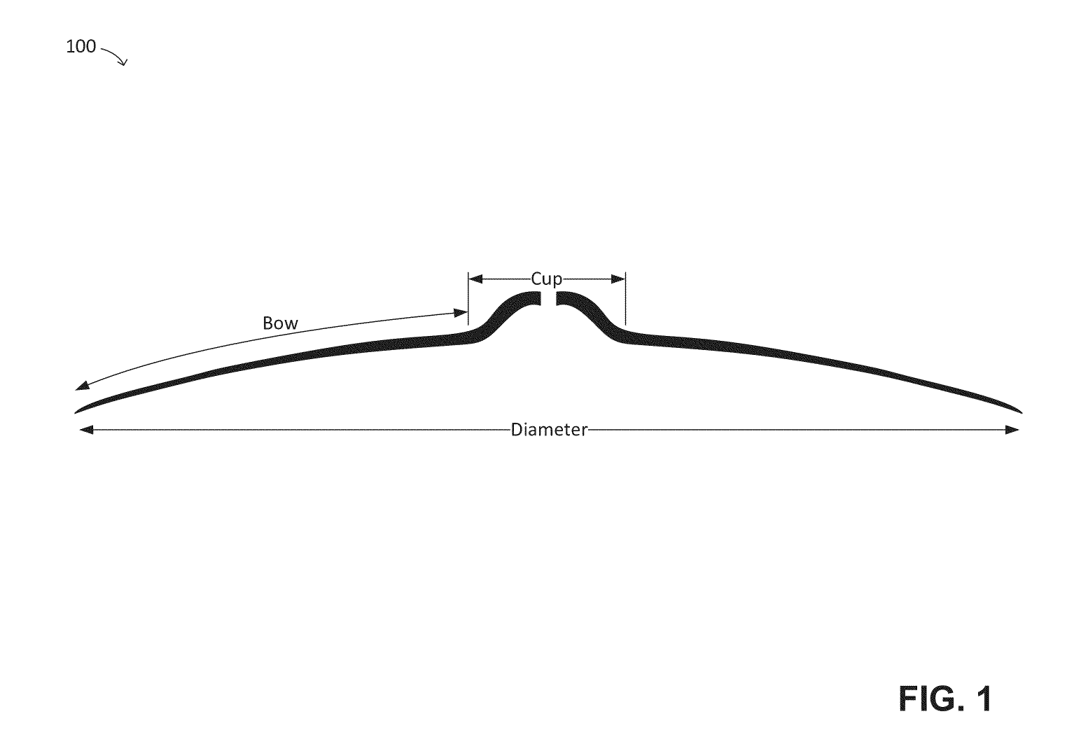

FIG. 1 depicts a cross-section of an illustrative cymbal suitable for practicing some embodiments. FIG. 1 illustrates regions typically associated with metal cymbals, including a region in the center of the cymbal sometimes referred to as a “cup” or a “bell,” and a region extending outward from the cup region, sometimes referred to as the “bow” region. It should be appreciated that nickel brass cymbals discussed herein may be of any suitable size and/or shape, though may in some embodiments have the general form shown in FIG. 1. The specific dimensions of each region may be of any suitable size, however, both in terms of absolute sizes and relative sizes. For example, a cymbal having a small or negligible cup region may be used with embodiments described herein.

Cymbal 101 may comprise a combination of materials, though may preferably be primarily formed from a nicked brass, examples of which are described herein. In some embodiments, cymbal 101 is constructed from a material that is suitably rigid so as to produce sounds when struck and/or has a hardness such that repeated strikes of the cymbal will not significantly dent or damage the material. In some embodiments, cymbal 101 comprises a nickel brass primarily comprising copper and further comprising zinc and nickel. As discussed above, the amount of nickel may be less than 12 percent by weight of the nickel brass, such as between 3 and 9 percent by weight.

Cymbal 101 may be of any suitable size and/or shape. In the example of FIG. 1, cymbal 100 is circular when viewed from above, and has the cross-section as shown. However cymbal 100 is not limited to cymbals that have this particular shape or cross-section, and it will be appreciated that the cymbal depicted in FIG. 1 is provided merely as one example. Moreover, cymbal 100 may be of any suitable size, including diameters between 6 inches and 30 inches, and thicknesses between 1 mm and 10 mm.

In some embodiments, cymbal 100 is of a size and shape corresponding to a particular categorization of cymbal types, including but not limited to cymbals commonly known as a ride, a crash, a hi-hat, a crash/ride, a splash, a China cymbal, and/or a marching cymbal. It will be appreciated that cymbal types, including those indicated above, may be formed in a variety of shapes and sizes, and that the types indicated are broad categorizations known to those of skill in the art.

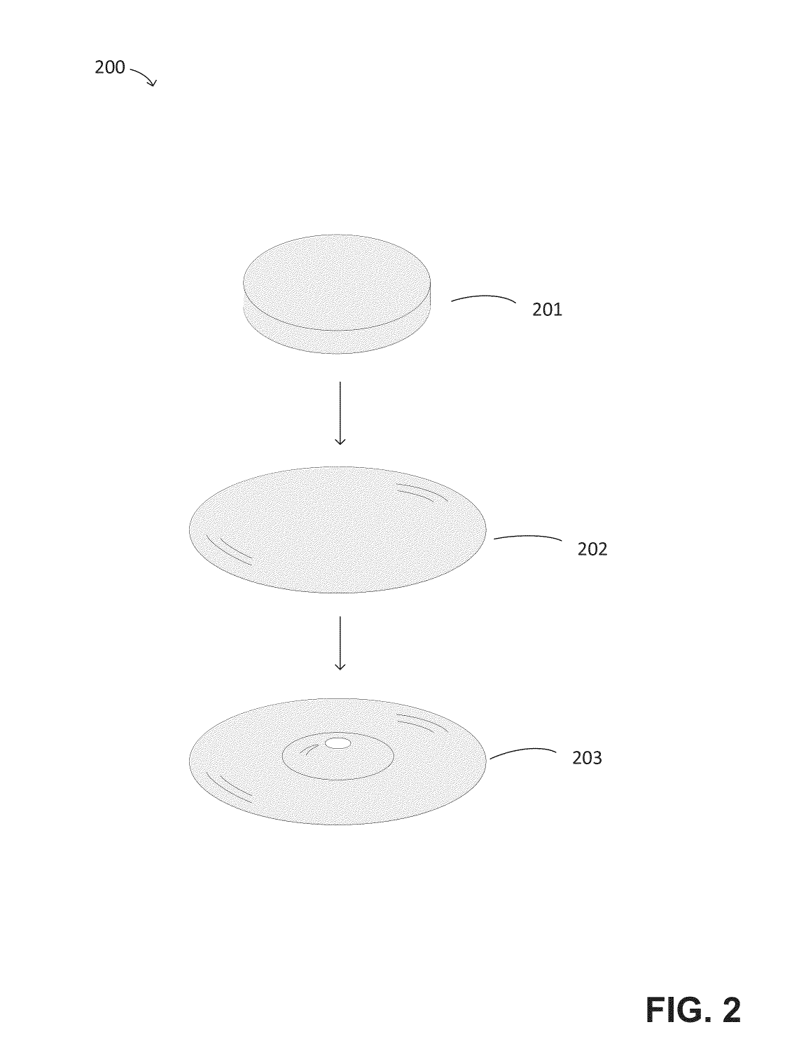

FIG. 2 illustrates a method of manufacturing a nickel brass cymbal, according to some embodiments. One or more steps illustrated in method 200 may be similar, and/or substantially identical to, steps that may be followed in the production of a conventional bronze cymbal. Accordingly, any suitable steps and/or techniques that may be employed in the production of a conventional bronze cymbal may be utilized in method 200. It will be appreciated that while not every possible technique that may be utilized to produce the nickel brass cymbal described herein is described below, any suitable technique or techniques known to those skilled in the art may be employed in the process of manufacturing the nickel brass cymbal, including both those discussed below and any not discussed below.

Method 200 begins with step 201 in which a slab of nickel brass from which a cymbal will be made, is formed and/or provided. The nickel brass may comprise copper, zinc and nickel in any suitable amounts, examples of which are provided herein. For instance, the nickel brass may comprise approximately 70 percent copper by weight, approximately 24 percent zinc by weight and approximately 6 percent nickel by weight. The nickel brass in step 201 may be provided in any suitable way, including by melting (e.g. by melting and casting nickel brass) and/or by rolling nickel brass into a slab.

In step 202, the nickel brass slab is rolled or otherwise shaped into the general shape of the cymbal being formed. For instance, the nickel brass slab may be rolled into a flatter disc and then cut into the shape of a circle. Step 202 may be performed in any suitable way, and may include a step of heating up the nickel brass slab prior to rolling. Any number of rolling operations may be performed, and in any number of directions. For instance, the nickel brass slab may be rolled a plurality of times in different directions before it is cut.

In step 203, the metal disc is shaped into the final shape of the nickel brass cymbal. Shaping may include, but is not limited to, cupping (forming a cup or bell shape in the center of the cymbal), cutting a hole in the center of the cymbal, lathing (e.g. shaving metal from the surface of the cymbal), hammering, backbending, pressing, buffing, metal spinning, shear forming, or any combination thereof, in any suitable sequence.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Where ranges of metal content are discussed herein, they are intended to encompass the endpoints of those ranges. For instance, where a material is indicated as comprising between 5 and 10 percent of a metal by weight, the material may include any amount of that metal between 5 and 10 percent by weight in addition to including 5 percent by weight or 10 percent by weight.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method of manufacture, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A cymbal comprising:
a nickel brass primarily comprising copper and further comprising zinc and nickel, wherein the nickel brass comprises between 3 and 9 percent nickel by weight.

2. The cymbal according to claim 1, wherein the nickel brass comprises between 20 and 28 percent zinc by weight.

3. The cymbal according to claim 2, wherein the nickel brass comprises between 22 and 26 percent zinc by weight and between 4 and 8 percent nickel by weight.

4. The cymbal according to claim 3, wherein the nickel brass comprises between 23 and 25 percent zinc by weight and between 5 and 7 percent nickel by weight.

5. The cymbal according to claim 4, wherein the nickel brass comprises approximately 24 percent zinc by weight and approximately 6 percent nickel by weight.

6. The cymbal according to claim 1, wherein the nickel brass comprises between 19.2 and 20.2 percent zinc by weight and between 4.7 and 5.3 percent nickel by weight.

7. The cymbal according to claim 1, wherein the nickel brass comprises between 69 and 76 percent copper by weight.

8. The cymbal according to claim 1, wherein the nickel brass comprises between 69 and 71 percent copper by weight and between 5.7 and 6.3 percent nickel by weight.

9. The cymbal according to claim 1, wherein the nickel brass comprises approximately 24.5 percent zinc by weight and approximately 5.5 percent nickel by weight.

10. The cymbal according to claim 1, wherein the nickel brass comprises tin.

11. The cymbal according to claim 1, wherein the nickel brass comprises iron in an amount that is less than 1 percent iron by weight.

12. The cymbal according to claim 1, wherein the nickel brass comprises manganese in an amount that is less than 1 percent manganese by weight.

13. The cymbal according to claim 1, wherein the nickel brass has a yield strength greater than 20 ksi.

14. The cymbal according to claim 1, wherein the nickel brass has a yield strength greater than 40 ksi.

15. The cymbal according to claim 14, wherein the nickel brass has a yield strength between 50 ksi and 100 ksi.

16. A method of producing a cymbal, comprising:
forming the cymbal from a nickel brass primarily comprising copper and further comprising zinc and nickel, wherein the nickel brass comprises between 3 and 9 percent nickel by weight.

17. The method according to claim 16, wherein the nickel brass comprises between 22 and 26 percent zinc by weight and between 4 and 8 percent nickel by weight.

18. The method according to claim 17, wherein the nickel brass comprises between 23 and 25 percent zinc by weight and between 5 and 7 percent nickel by weight.

19. The method according to claim 16, wherein the nickel brass has a yield strength between 50 ksi and 100 ksi.
